(19) United States
(12) Patent Application Publication
(10) Pub. No.: US 2026/0351033 A1
(43) Pub. Date: Nov. 5, 2026

(54) SYSTEM AND METHOD FOR IMPROVING OPTICAL CHARACTER RECOGINITION (OCR) PROCESSING OF DOCUMENTS

(71) Applicant: KYOCERA DOCUMENT SOLUTIONS, INC., Osaka (JP)

(72) Inventors: Benny WONG, Concord, CA (US); Selim ZAMAN, San Mateo, CA (US)

(73) Assignee: KYOCERA DOCUMENT SOLUTIONS, INC., Osaka (JP)

(21) Appl. No.: 19/195,199

(22) Filed: Apr. 30, 2025

(51) Int. Cl. G06V 30/16; G06V 10/96; G06V 30/41

(52) U.S. Cl. CPC G06V 30/16; G06V 10/96; G06V 30/41

(57) ABSTRACT

A system and method for optimizing OCR (optical character recognition) processing on a bulk of uploaded documents are described. The system and method categorize the uploaded documents based on their file sizes and content types, match the specifications and functions of a list of OCR engines with the content types of the uploaded documents, and sends the uploaded documents to job queues of their matching OCR engines for OCR processing. The system and method monitor the job instances of the job queues and re-order the job instances to maintain no more than a predetermined number of large documents are consecutively queued in front of small documents, thereby a more efficient and rapid OCR processing is provided.

### FIELD OF THE INVENTION

The present invention relates to a system and method for performing optical-character-recognition (OCR) on uploaded documents. In particular, the present invention relates to a method and a system that are capable of efficiently performing OCR on a batch of uploaded documents.

### DESCRIPTION OF THE RELATED ART

Optical Character Recognition (OCR) is a technology that converts a scanned image of printed text into machine readable PDFs. When performing the OCR on multiple scanned documents uploaded in bulk, users experience a long wait time due to the serial processing of the multiple documents. For larger documents, it takes longer time to perform the OCR than smaller documents.

Currently, there are no document managing systems and methods that can solve this problem without requiring manual intervention.

### SUMMARY OF THE INVENTION

A method for improving optical character recognition (OCR) performance of uploaded documents is disclosed. The method includes storing the plurality of uploaded documents to a database. The method also includes assessing files sizes and content types of the plurality of uploaded documents. The method also includes categorizing the plurality of uploaded documents based on the content types of the plurality of uploaded documents. The method also includes distributing the plurality of uploaded documents to different job queues for different OCR engines based on the content types for OCR processing.

The method further includes scanning the plurality of uploaded documents to assess the file sizes and the content types of the plurality of uploaded documents and to categorize the plurality of uploaded documents based on the types of the content. The content types include plain texts, pictures, or linguistic contents.

The above method further includes categorizing the plurality of uploaded documents based on predetermined threshold values to categorize large documents and small documents, prioritizing the small documents over the large documents for OCR processing, performing the OCR processing on the small documents with at least one OCR engine, and performing the OCR processing on the large documents on a first-in-first-out (FIFO) basis with the at least one OCR engine.

In accordance with the disclosed embodiments, the predetermined threshold values include a predetermined page count and a predetermined density. The predetermined page count is a predetermined number of pages of each of the plurality of uploaded documents, and the predetermined density is predetermined pixel numbers per inch.

If there are multiple OCR engines, the method further includes distributing the large documents to more than one OCR engines for the OCR processing.

The different OCR engines are chosen based on characteristics of the different OCR engines that suit the content types of the plurality of uploaded documents for the OCR processing according to at least one criterion. Further, the plurality of uploaded documents may be saved in different databases based on the content types.

The method of claim 1, further including monitoring uploaded documents received in the different job queues for the different OCR engines periodically or by demand.

If there are more than a predetermined number of large documents consecutively presented in front of the small documents in any one of the different job queues, the method further includes re-ordering the large documents and the small documents in the any one of the different queues by prioritizing a certain number of consecutive small documents after the predetermined number of large documents.

Yet another method for improving optical character recognition (OCR) performances of a plurality of documents is disclosed. This method includes assessing files sizes and content types of the plurality of uploaded documents, categorizing the plurality of uploaded documents based on the content types of the plurality of uploaded documents, distributing the plurality of uploaded documents to different job queues for different OCR engines based on the content types, monitoring the different job queues periodically or by demand, and prioritizing a first set of documents over a second set of documents received in each of the different job queues for OCR processing. The first set of documents are categorized as small documents and the second set of documents are categorized as large document based on predetermined threshold values.

The above method further includes categorizing the plurality of uploaded documents based on the predetermined threshold values to categorize the first set of documents and the second set of documents, in which the file sizes of the first set of documents are no larger than the predetermined threshold values and the file sizes of the second set of documents are larger than the predetermined threshold values, performing the OCR processing on the small documents first with at least one OCR engine, and performing the OCR processing on the large documents on a first-in-first-out (FIFO) basis with the at least one OCR engine.

In the above method, if there are more than a predetermined number of large documents consecutively presented in front of the small documents in any one of the different job queues, the method further includes re-ordering the large documents and the small documents in the any one of the different job queues by prioritizing a certain number of consecutive small documents after the predetermine number of large documents of the large documents for the OCR processing.

The predetermined threshold values include a predetermined page count and a predetermined density, the predetermined page count is a predetermined number of pages of each of the plurality of uploaded documents, and the predetermined density is predetermined pixel numbers per inch. Further, the different OCR engines are chosen based on characteristics of the different OCR engines that match the content types of the plurality of uploaded documents for the OCR processing according to at least one criterion. The content types may include plain texts, pictures, or linguistic contents.

A system for performing OCR (Optical Character Recognition) on bulk uploaded documents is disclosed. The system includes a database for storing a plurality of uploaded documents. The system also includes a managing device accessible to the plurality of uploaded documents stored in the storage. The managing device includes a processor. The storage further stores medium-readable instructions, which when executed, causes the processor to store the plurality of uploaded documents to the database, assess files sizes and content types of the plurality of uploaded documents, categorize the plurality of uploaded documents based on the file sizes and the content types of the plurality of uploaded documents, and distribute the plurality of uploaded documents to different job queues for different OCR engines based on the content types for OCR processing.

The processor is further configured to monitor the different job queues periodically or by demand, categorize the plurality of uploaded documents based on predetermined threshold values to a first set of documents and a second set of documents. The first set of documents are categorized as small documents, of which the file sizes are no larger than the predetermined threshold values, and the second set of documents are categorized as large document of the file sizes are larger than the predetermined threshold values, and prioritize the first set of documents over the second set of documents received in each of the different job queues for OCR processing. The predetermined threshold values include a predetermined page count of each of the plurality of uploaded documents and a predetermined density. The predetermined density is predetermined pixel numbers per inch.

In the disclosed system, if there are more than a predetermined number of large documents consecutively presented in front of the small documents in any one of the different job queues, the processor is further configured to re-order the large documents and the small documents in the any one of the different job queues by prioritizing a certain number of consecutive small documents after the predetermine number of large documents of the large documents for the OCR processing.

The different OCR engines are chosen based on characteristics of the different OCR engines that characteristically match of the plurality of uploaded documents for the OCR processing according to at least one criterion.

### BRIEF DESCRIPTION OF THE DRAWINGS

Various other features and attendant advantages of the present invention will be more fully appreciated when considered in conjunction with the accompanying drawings.

FIG. 1 depicts a block diagram of a document management system in accordance with the disclosed embodiments.

FIG. 2 depicts an exemplary block diagram showing how to re-order the job instances received in a job queue in accordance with the disclosed embodiments.

FIG. 3 depicts a flowchart for arranging the job instances of a job queue in accordance with the disclosed embodiments.

FIG. 4 depicts a flowchart for splitting a large document into a number of segmented small documents and performing OCR-processing on the number of segmented small documents in accordance with the disclosed embodiments.

FIG. 5 depicts a flowchart for performing OCR processing on uploaded or incoming documents in accordance with the disclosed embodiments.

### DETAILED DESCRIPTION OF THE EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments provide a document management system and method for improving the efficiency of performing OCR (Optical Character Recognition) on multiple uploaded documents. The OCR is a technology that scans documents to convert them from non-searchable format to searchable format. The OCR processing is asynchronous and the time it takes to process each uploaded document varies based on a file size and resolution (DPI) of its content. For large sized and/or high-resolution files, the process can take a long time especially if a large number of files are queued for the OCR processing. To avoid a longer processing time the large documents may cause, the disclosed embodiments disclose a document management system and method for assessing the uploaded documents to categorize their content types and sending the uploaded documents to specific OCR engines accordingly. Examples of the content types may include a plain text content type, a picture content type, a linguistic content type, and so on. All the uploaded documents may be saved in a master job queue and be assessed to determine their content types and file sizes. The master job queue may be a storage. The disclosed embodiments include a plurality of OCR engines that have different functional characteristics. For example, some OCR engines have built-in functions for distinguishing multi-languages contained in a document; while some OCR engines are capable of distinguishing pictures and by matching the content types of the incoming/uploaded documents with the functional characteristics of the plurality of OCR engines, the disclosed embodiments determine which OCR engine would process which content type of the uploaded documents, and send uploaded documents to job queues of specific OCR engines for OCR processing.

The disclosed embodiments further provide a document management system and method for monitoring each job queue of the plurality of OCR engines for sizes and re-ordering the job instances if there are more than a predetermined number of large documents queued before a small document. The system and method may also split the large documents into several segmented small documents and send the several segmented small documents to different OCR engines for parallel OCR processing. Each of the several segmented small documents may be inserted or embedded with a marker so that after the OCR processing, the several segmented small document files may be combined together based on the embedded markers to restore the original documents with a searchable format.

By splitting large documents into multiple segmented small document files and performing OCR on the multiple document files instead of a sequence of large and small documents, the processing time for performing the OCR on a bulk of uploaded documents can be reduced. The disclosed embodiments split a large document that is greater than the file size threshold into multiple segmented small document files and insert or embed markers on the multiple segmented document files. Each of the markers indicates a location or an order of respective segmented document file in the same large document. After all of the segmented document files have processed through the OCR node, the multiple segmented document files are merged back together to restore the original document in a searchable PDF format based on the markers embodied therein. The markers are stored in a memory cache. The markers then will be deleted after the large document or all of the large documents are processed completely or reset by a user.

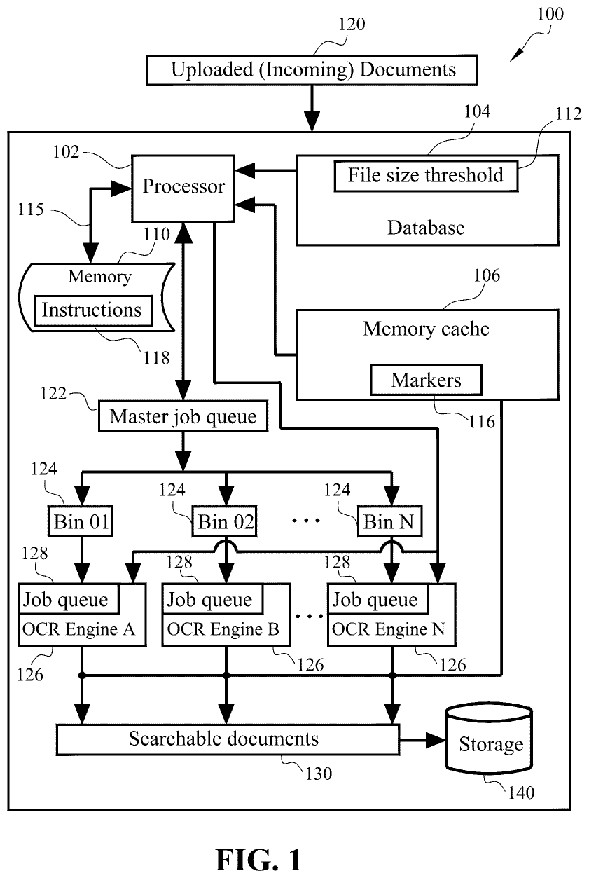

FIG. 1 illustrates a block diagram of a document management system 100 according to the disclosed embodiments. Document management system 100 receives and processes a bulk of uploaded or incoming non-searchable documents 120 before sending them to OCR engines for the OCR performance. In the following descriptions, the bulk of uploaded or incoming documents may be collectively known as “uploaded documents,” “a plurality of uploaded documents,” or a “bulk of uploaded documents.”

Document management system 100 includes a processor 102 that is connected to memory 110 by data bus 115. Memory 110 includes instructions 118. Instructions 118 may be code that, when read by processor 102, causes system 100 to perform the operations disclosed herein. System 100 also includes a database 104 that stores a file size threshold 112 that is used by processor 102 to determine whether an uploaded document is categorized as a large document or a small document. A file size of a document may be determined by a page count (i.e., the number of pages) and a resolution of the uploaded document. For the purpose of illustration, the threshold parameter for the page count (i.e., page count limit) may be 10 pages and the threshold parameter for the resolution (i.e., resolution limit) may be 300 dpi. Therefore, if the file size of document has a page count larger than 10 pages and the resolution of the document is larger than 300 dpi, this document is considered as a large document and can be split into smaller document files, if needed. A formula for calculating how many document files can be split from a large document may be n=Roundup of [(page count*dpi)/(page count limit*dpi limit)]. For example, an uploaded document with 20 pages and 300 dpi can be split to two document files, an uploaded document with 20 pages and 600 dpi can be split into 4 document files, and so on. An uploaded document will be categorized as a large document if its page count or the resolution is equal to or more than file size threshold 112 and as a small document if its page count or the resolution is not more than file size threshold 112.

Processor 102 is also configured to categorize the uploaded or incoming documents based on their content types. Based on the content types of the uploaded documents and the specifications of available OCR engines, processor 102 determines which OCR engines can be used to OCR-process the uploaded documents and send the uploaded documents to the corresponding OCR engines. There is a master job queue upon which the processor acts to analyze, categorize and prioritize jobs for downstream processing through the job queue for each OCR engine 126). More details will be described below.

In the disclosed embodiments, uploaded documents 120 may be sent to a master job queue 122 There, processor 102 determines the file sizes of uploaded documents 120 and their content types. As described above, processor 102 determines an uploaded document as a large document if its file size is equal to or larger than the file size threshold, and as a small document if its file size is not larger than the file size threshold. In the uploaded documents 120, processor 102 prioritizes the small documents over the large documents for OCR processing. Then, processor 102 performs the OCR processing on the small documents with at least one OCR engine. Processor 102 also performs the OCR processing on the large documents on a first-in-first-out (FIFO) basis with the OCR engine. Processor 102 further categorizes the content types of uploaded documents determined by scanning a few sample pages of each of uploaded documents 120. The content types may include plain content types (i.e., one single language,) linguistic content types (i.e., multiple-language content types), graphic or picture content types, hand-writing content types, and the like. When an uploaded document contains multiple-language contents, processor 102 further analyzes whether the multiple-language contents are non-Latin language but simple contents, Latin language but simple contents, non-Latin language but complexed contents, or Latin language but complexed contents. In some embodiments, based on the content types, processor 102 may sort these contents to separate bins 124. However, processor 102 may directly send the uploaded documents to job queues 128 of different OCR engines 126 according to their content types.

System 100 further includes at least one OCR engine, and more preferably, a plurality of OCR engines 126 when there are a large number of documents are uploaded to system 100 at the same time. OCR engines 126 may have different specifications and functions. For example, OCR engine A is mainly designed to perform OCR processing on plain contents, OCR engine B can further perform OCR processing on the picture contents in addition to the plain contents, OCR engine C is preferred for multiple-language contents, etc. FIG. 1 only shows three OCR engines, but the number of the OCR engines are not limited to three only. Processor 102 refers to the functions of the plurality of OCR engines 126 to find proper OCR engines that best-match the content types of the uploaded documents 120 and send the uploaded documents 120 to job queues 128 of the matched OCR engines for processing.

According to the disclosed embodiments, it is not necessary to split the large documents before sending them to the job queues of the OCR engines. After the uploaded documents are sent to job queues 128, processor 102 will continue monitoring the job instances received in each job queue 128. To speed up the OCR processing, it is preferable that the OCR engines process the small documents first as processing the large documents takes a longer time. In accordance with the disclosed embodiments, it is preferable that no more than a first predetermined number of large documents are queued sequentially before the small documents. In some embodiments, no more than a second predetermined number of the small documents are processed before the first predetermined number of large documents. In other embodiments, the small documents and the large documents are queued alternatively. For example, the first predetermined number of large document and the second predetermined number of small documents are queued alternatively. The order of the large documents and the small documents can be changed based on the specifications and process speeds of the OCR engines 126. In either embodiment, no more than the first predetermined number of large documents should be processed sequentially before any number of small documents. Processor 102 is configured to monitor the job queue of each OCR engine and re-order the job instances if there are more than the second predetermined number of large documents are in the queue consequently or before the small documents, for example. For example, more than a first predetermined number of large documents are queued sequentially before the small documents, the order of the large documents and the small documents can be changed based on the specifications and process speeds of the OCR engines 126. Also, if the large document is queued before the small document, the order of the large documents and the small documents can be changed based on the specifications and process speeds of the OCR engines 126.

The first predetermined number and the second predetermined number are configurable by a system administrator based on the specifications of the OCR engines 126 and their processing speed. If a performance of a specific OCR engine is low, then the first predetermined number and the second predetermined number will be set low, and vice versa. The first predetermined number is larger than the second predetermined number. In some embodiments, there is no limitation of how many small documents are queued and processed before the large documents.

Alternatively, if there are enough OCR engines 126 to process different content types of documents, or there are a large number of large documents in job queues 128, processor 102 may be configured to split the large documents into a number of small documents based on the predetermined file size threshold 112 and send the number of small documents to different OCR engines for parallel processing. In this case, the large document will be divided or split into a number of segmented small documents, each of which the file size is smaller than file size threshold 112.

When a large document is split to a number of segmented small documents, processor 102 is further configured to generate markers 116 indicating locations and/or orders of the number of segmented small documents in the original large document and to insert or embed markers 116 to corresponding segmented small documents. Markers 116 are used to aggregate the number of segmented small documents into the original large document after all of the number of small documents are processed by the OCR engines. All of markers 116 belonging to a same large document will be stored together in a memory cache 106 and will be deleted after the aggregation of the same large document is completed.

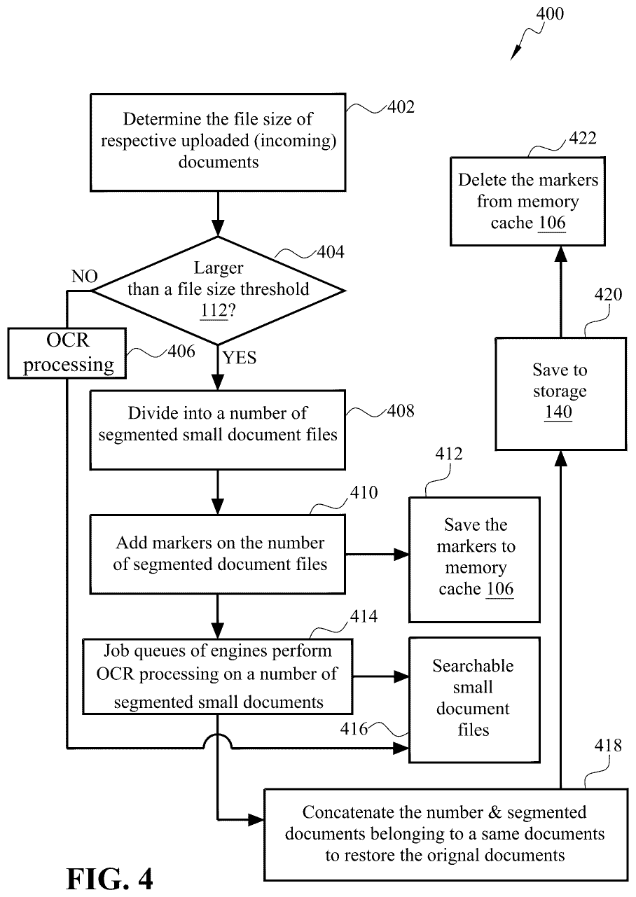

OCR engines 126 process the documents received in OCR job queues 128 to generate searchable document files 130. The searchable document files may be PDF files that have same content as the original document files, but in a searchable form. As described above, some of the searchable document files are split from at least one large document. Therefore, before saving these split searchable document files to storage 140, processor 102 will concatenate or aggregate these split searchable document files to restore their respective large documents based on markers 116 embedded therein. The features of restoring large documents will be described in more detail in FIG. 4.

By sending the uploaded documents to proper OCR engines that can perform the OCR processing more efficiently based on their content types, and by maintaining the job instances received in the job queue in proper order, the time it takes to perform the OCR for the uploaded documents can be greatly reduced. The job instance order may depend on the specifications and processing speeds of the OCR engines. For example, in addition to the examples described above, the OCR engines may process the small documents first, and process the large documents in first-in-first-out (FIFO) manner.

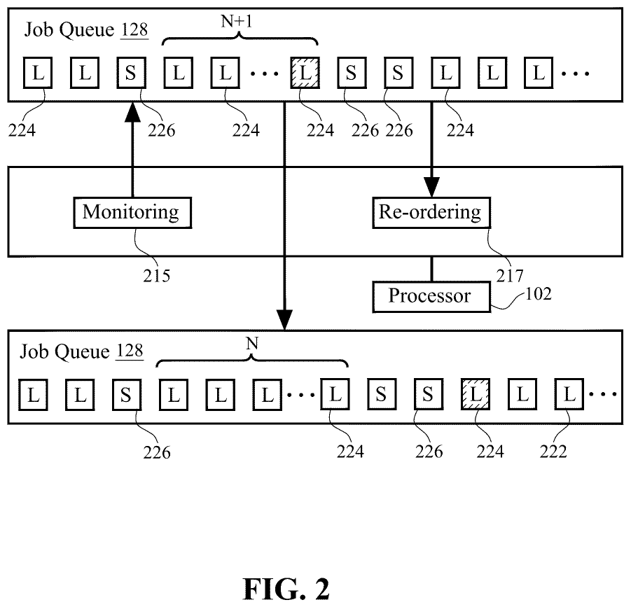

FIG. 2 depicts an exemplary block diagram showing how processor 102 re-orders the job instances received in a job queue in accordance with the disclosed embodiments. As shown in FIG. 2, the job instances received in job queue 128 includes large documents 138 and small documents 139. The large documents 138 have file sizes equal to or larger than the file size threshold 112 and the small documents 139 have file sizes no larger than the file size threshold 112.

Job instances may include a number of large documents 138 and small documents 139, which are queued in job queue 128 on a timely basis, i.e., by the order when they are received. Processor 202 is configured to monitor (shown by reference number 215) the job instances received in job queue 128 and to re-order (shown by reference number 217) the job instance if certain conditions happen. One of the conditions may be when more than the second number of large documents are queued sequentially in front of small documents. The second number may be N, such as 10, for example. In FIG. 2, the top job queue 128 shows that there are N+1 large documents 224 queued before small document 226. In this case, processor 102 may be activated to re-order the N+1 large documents 224 by moving one of large documents 224 (the shaded one in FIG. 2) to be behind small document 226, as shown in the bottom job queue 228. If there are N+2 or more large documents 224 queued before small documents 226, then processor 102 would move 2 or more large documents 224 to be behind small documents 226, and would make sure the added-on large documents will not cause another string of more than N large documents queued before other small documents.

According to the disclosed embodiments, by limiting the number of consecutive large documents in front of small documents, these features will ensure that OCR engine 126 can more efficiently and rapidly perform OCR processing on all documents (i.e., job instances) received in job queue 128.

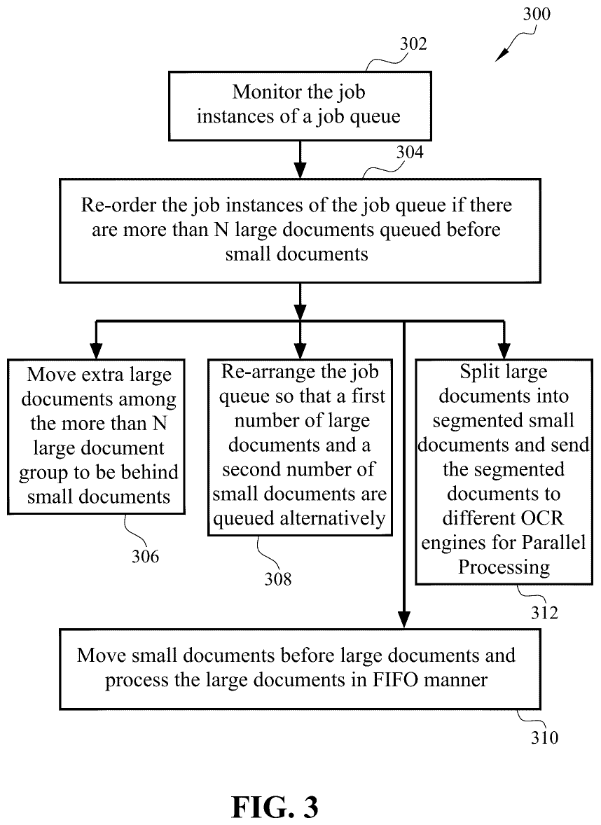

FIG. 3 depicts a flowchart 300 for arranging the job instances of a job queue using system 100 in accordance with the disclosed embodiments. Flowchart 300 further describes how the job instances received in job queue 128 may be re-ordered.

Step 302 executes by monitoring the job instances of job queues 128 of OCR engines 126. Where more than N large documents, i.e., a string of N+n large documents, are queued sequentially before a small document, step 304 then executes by re-ordering the job instances of the job queue order, by re-ordering the job instances of the job queue order by pushing out n large documents later in the queue after smaller documents to be processed. Monitoring and re-ordering may be performed by processor 102, as described above.

There are various ways for system 100 to re-arrange the job instances of the job queue in accordance with the disclosed embodiments. Step 306 executes by moving n large documents from the string of N+n large documents to be behind small documents. The step makes sure that no more than N large documents are queued consecutively before small documents.

Alternatively, step 306 may execute by re-arranging the job instances so that a first number of large documents and a second number of small documents are queued alternatively in the job queue. In this manner, it is preferable that the small documents are processed before the large documents, but not limited thereto.

Another embodiment is to move the small documents before large documents, and to set up that the large documents will be processed in a FIFO (first-in-first-out) manner, as shown in step 310.

Furthermore, step 312 may execute by splitting the large documents into a number of segmented small documents and sending the number of segmented small documents to various OCR engines for parallel OCR-processing. Step 312 may be executed when there are enough OCR engines to process OCR on the content types of the number of segmented small documents, or when there are too many large documents, for example, more than a predetermined number, in the job queues of the OCR engines, or some uploaded documents are prioritized due to the request of specific clients, such as VIP clients, of system 100.

Step 312 may also be executed before the uploaded documents are sent to job queues 126 of OCR engines 128. That is, as described in FIG. 1, in addition to categorize the content types of uploaded documents 120 when the uploaded documents are received or sent to master job queue 122, processor 102 of system 100 may also categorize the uploaded documents 120 to be the large documents and the small documents based on their file sizes. Processor 102 may then split the large documents into a number of segmented small documents, determine the content types of the number of segmented small documents, and send the number of segmented small documents to the job queues of various OCR engines for processing.

FIG. 4 illustrates a flowchart 400 for splitting a large document into a number of segmented small documents and performing OCR-processing on the number of segmented small documents in accordance with the disclosed embodiments. Same elements mentioned in previous FIGS. 1 and 2 will be marked with same reference numbers in FIG. 4. It is noted that uploaded document or incoming documents 120 are non-searchable documents, such as non-searchable scanned PDF files. By perform OCR-processing on the non-searchable scanned PDF files, it generates searchable PDF files of uploaded documents 120. Furthermore, for the purpose of simplification, the method of FIG. 4 will be executed after uploaded documents are sent to job queues 128 of OCR engines 126. Only one job queue of one OCR engine will be described here as an example.

Step 402 executes by determining the file sizes of documents received in the job queue. As defined above, the file size of the document may be determined by a page count and a resolution thereof.

Step 404 executes by comparing the file sizes of the documents with file size threshold 112. If the answer is no, then the compared uploaded document is categorized as a small document. The small document is then sent to the OCR engine for OCR-processing, as shown at step 406.

If, however, the answer of step 404 is yes, then the compared document is categorized as a large document. Therefore, step 408 executes by dividing or splitting the large document into a number of segmented small document files. Meanwhile, step 410 executes by generating and inserting or embedding markers to the number of segmented small document. The markers may be metadata, identifiers, or indexes that define the locations and/or orders of the number of segmented small document in the large document. Step 412 executes by saving all markers to memory cache 106. The markers that belong to a same large document will be saved together in memory cache 106.

Next, step 414 executes by sending the number of segmented small documents to at least one OCR node for processing. Preferably, if there are sufficient number of OCR engines, the number of segmented small documents will be sent to various OCR engines for parallel-processing.

After all the small documents and the number of segmented documents is processed by at least one OCR engines, a plurality of searchable document files are generated at step 416.

Next, step 418 executes by concatenating all segmented small documents that belong to a same large document based on their locations and orders defined by markers embedded therein to restore the same large document in a searchable form.

Step 420 executes by storing the restored searchable large document and the searchable small document to storage 140 for further use. After all of the segmented small document files are saved to storage 140, the markers embedded therein to restore the same large document in a searchable form stored in memory cache 106 will be deleted, at step 422.

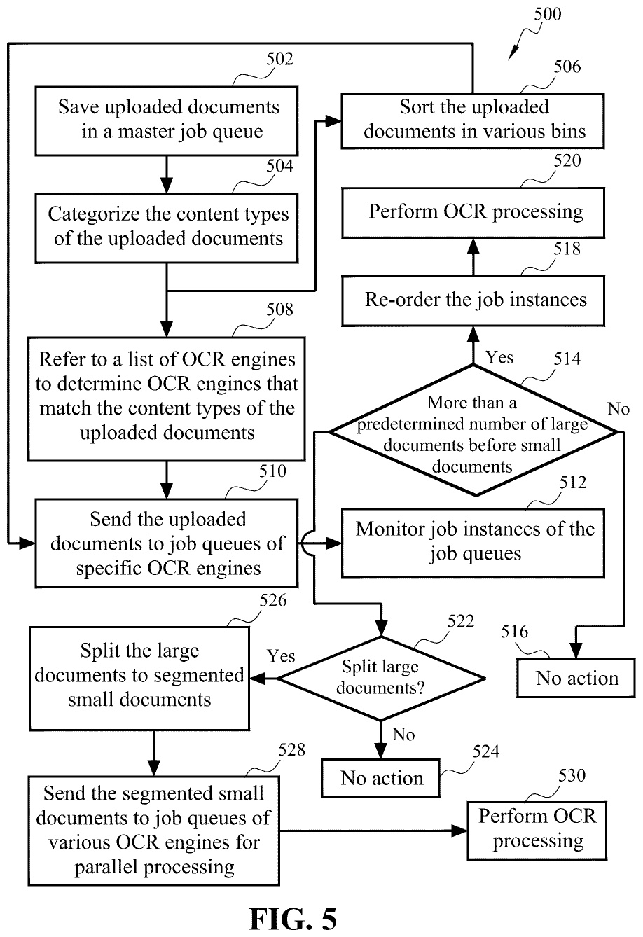

FIG. 5 further illustrates a flowchart 400 for performing OCR processing on uploaded or incoming documents in accordance with the disclosed embodiments.

As shown at step 502, when system 100 receives uploaded documents, system 100 saves the uploaded documents in a master job queue, such as master job queue 122 of FIG. 1. The uploaded documents may also be saved to a database that is accessible by system 100.

Step 504 executes by categorizing the content types of the uploaded documents. In the disclosed embodiments, the content types may be categorized as plain text contents, picture contents, linguistic contents, and so on. As described in FIG. 1, the linguistic-content category may further include sub-categories, such as Latin-simple contents, Latin-complex contents, non-Latin-simple contents, non-Latin complex contents, or the like. In some embodiments, those sub-categories may be sorted and saved in various bins for further analysis, as shown at step 506. Step 506 may be optional and the disclosed embodiments are not limited thereto.

Next, step 508 executes by referring to the specifications of a list of available OCR engines to determine which OCR engines are suitable to process (or match) different content types of the uploaded documents. After step 508, step 510 executes by sending the uploaded documents to job queues of the suitable OCR engines.

Step 512 executes by monitoring the job instances, i.e., documents, received in the job queues of the OCR engines. The feature of monitoring the job instances of the job queues can be done periodically or by demand. The purpose of monitoring the job queues is to ensure that the OCR processing of the job instances can be performed more efficiently.

Step 514 executes by determining if there are more than a predetermined number of large documents are queued consecutively before a small document. If the answer is no, then no action is needed, as shown at step 516. If the answer is yes, then step 518 executes by re-ordering the job instances of the job queue, as shown at step 520. The re-ordering method has been described above with reference to FIG. 3.

Step 522 further executes by determining if it is necessary to split at least one large document into smaller segmented documents. The determination will be based on certain conditions, such as if there are a sufficient number of OCR engines that can process different content types of the documents exist, if some large documents have higher priorities for OCR processing, or if there are too many large documents received in the job queues.

If the answer for step 522 is no, then no action will be taken, as shown at step 524. However, if the answer is yes, step 526 then executes by splitting the large documents into a number of segmented small documents. As described in FIG. 4, each of the segmented small document files is inserted or embedded with a marker. The markers may be metadata, identifiers, or indexes that indicate the locations and/or orders of the segmented small document files are in the large document. The makers may be stored in a memory cache (106 of FIG. 1) and will be deleted after the large document is restored or be reset by a user.

Next, step 528 executes by sending the number of segmented small documents to job queues of multiple OCR engines for parallel processing. Parallel processing the number of segmented small documents that belong to a same large document may further reduce the OCR-processing time.

After that, step 530 executes by performing the OCR processing on the number of segmented small documents. The number of segmented small documents may be concatenated to restore the original large documents based on the markers, but in a searchable form.

It is noted that when there are more than one OCR engines in use to perform the OCR, it is preferable that the segmented small document of a same large document is sent to different OCR nodes for processing in parallel. Processing segmented small document files in parallel to a same large document further improves the processing time for the large documents. However, when only a single OCR node is used, all small documents and segmented small document will be sent to the single OCR engine for processing. In this case, if the segmented small document files are queued in the front of the job queue, then a client will experience a longer waiting time as the segmented small document. To avoid this from happening, the disclosed embodiments may prioritize the document files sent to OCR job queue 128. In general, the disclosed embodiments would prioritize the small document files over the segmented small document files, and prioritize the small document files with smaller file size over the small document files with larger file size. In some embodiments, the disclosed embodiment would process the segmented small documents in a first-come-first-serve manner or alternatively process small document files with segmented small document files.

Furthermore, the disclosed embodiments match the specifications and functions of a list of OCR engines with the content types of the uploaded documents and sends the uploaded documents to their matching OCR engines for OCR processing. This feature further enhances the efficiency of the OCR processing.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for performing Optical Character Recognition (OCR) processing of a plurality of uploaded documents, the method comprising:
storing the plurality of uploaded documents to a database;
assessing files sizes and content types of the plurality of uploaded documents;
categorizing the plurality of uploaded documents based on the content types of the plurality of uploaded documents; and
distributing the plurality of uploaded documents to different job queues for different OCR engines based on the content types for OCR processing.

2. The method of claim 1, further comprising scanning the plurality of uploaded documents to assess the file sizes and the content types of the plurality of uploaded documents and to categorize the plurality of uploaded documents based on the types of the content types.

3. The method of claim 2, wherein the content types include plain texts, pictures, or linguistic contents.

4. The method of claim 1, further comprising:
categorizing the plurality of uploaded documents based on predetermined threshold values to categorize large documents and small documents;
prioritizing the small documents over the large documents for OCR processing;
performing the OCR processing on the small documents with at least one OCR engine; and
performing the OCR processing on the large documents on a first-in-first-out (FIFO) basis with the at least one OCR engine.

5. The method of claim 4, wherein the predetermined threshold values include a predetermined page count and a predetermined density, wherein the predetermined page count is a predetermined number of pages of each of the plurality of uploaded documents, and the predetermined density is predetermined pixel numbers per inch.

6. The method of claim 4, if there are multiple OCR engines, further comprising distributing the large documents to more than one OCR engines for the OCR processing.

7. The method of claim 1, wherein the different OCR engines are chosen based on characteristics of the different OCR engines that match the content types of the plurality of uploaded documents for the OCR processing according to at least one criterion.

8. The method of claim 1, wherein the plurality of uploaded documents is saved in different databases based on the content types.

9. The method of claim 1, further including monitoring uploaded documents received in the different job queues for the different OCR engines periodically or by demand.

10. The method of claim 9, if there are more than a predetermined number of large documents consecutively presented in front of the small documents in any one of the different job queues, further including re-ordering the large documents and the small documents in the any one of the different queues by prioritizing a certain number of consecutive small documents after the predetermined number of large documents.

11. A method for performing Optical Character Recognition (OCR) processing of a plurality of uploaded documents, the method comprising:
assessing files sizes and content types of the plurality of uploaded documents;
categorizing the plurality of uploaded documents based on the content types of the plurality of uploaded documents;
distributing the plurality of uploaded documents to different job queues for different OCR engines based on the content types;
monitoring the different job queues periodically or by demand; and
prioritizing a first set of documents over a second set of documents received in each of the different job queues for OCR processing, wherein the first set of documents are categorized as small documents and the second set of documents are categorized as large document based on predetermined threshold values.

12. The method of claim 11, further comprising:
categorizing the plurality of uploaded documents based on the predetermined threshold values to categorize the first set of documents and the second set of documents, wherein the file sizes of the first set of documents are no larger than the predetermined threshold values and the file sizes of the second set of documents are larger than the predetermined threshold values;
performing the OCR processing on the small documents first with at least one OCR engine; and
performing the OCR processing on the large documents on a first-in-first-out (FIFO) basis with the at least one OCR engine.

13. The method of claim 11, if there are more than a predetermined number of large documents consecutively presented in front of the small documents in any one of the different job queues, further including re-ordering the large documents and the small documents in the any one of the different job queues by prioritizing a certain number of consecutive small documents after the predetermine number of large documents of the large documents for the OCR processing.

14. The method of claim 12, wherein the predetermined threshold values include a predetermined page count and a predetermined density, the predetermined page count is a predetermined number of pages of each of the plurality of uploaded documents, and the predetermined density is predetermined pixel numbers per inch.

15. The method of claim 11, wherein the different OCR engines are chosen based on characteristics of the different OCR engines that match the content types of the plurality of uploaded documents for the OCR processing according to at least one criterion.

16. The method of claim 11, wherein the content types include plain texts, pictures, or linguistic contents.

17. A system for performing Optical Character Recognition (OCR) processing on bulk uploaded document, the system comprising:
a database for storing a plurality of uploaded documents;
a managing device accessible to the plurality of uploaded documents stored in the storage, comprising a processor, wherein the storage further stores medium-readable instructions, which when executed, causes the processor to:
store the plurality of uploaded documents to the database;
assess files sizes and content types of the plurality of uploaded documents;
categorizing the plurality of uploaded documents based on the file sizes and the content types of the plurality of uploaded documents; and
distributing the plurality of uploaded documents to different job queues for different OCR engines based on the content types for OCR processing.

18. The system of claim 17, wherein the processor is further configured to
monitor the different job queues periodically or by demand;
categorizing the plurality of uploaded documents based on predetermined threshold values to a first set of documents and a second set of documents, wherein the first set of documents are categorized as small documents, of which the file sizes are no larger than the predetermined threshold values, and the second set of documents are categorized as large document of the file sizes are larger than the predetermined threshold values; and
prioritizing the first set of documents over the second set of documents received in each of the different job queues for OCR processing, wherein the predetermined threshold values include a predetermined page count of each of the plurality of uploaded documents and a predetermined density, wherein the predetermined density is predetermined pixel numbers per inch.

19. The system of claim 17, wherein if there are more than a predetermined number of large documents consecutively presented in front of the small documents in any one of the different job queues, the processor is further configured to re-order the large documents and the small documents in the any one of the different job queues by prioritizing a certain number of consecutive small documents after the predetermine number of large documents of the large documents for the OCR processing.

20. The system of claim 16, wherein the different OCR engines are chosen based on characteristics of the different OCR engines that match the content types of the plurality of uploaded documents for the OCR processing according to at least one criterion.
